(19) United States
(12) Patent Application Publication
(10) Pub. No.: US 2022/0282992 A1
(43) Pub. Date: Sep. 8, 2022

(54) METHOD AND APPARATUS FOR GENERATING ELECTRONIC MAP, ELECTRONIC DEVICE AND STORAGE MEDIUM

(71) Applicant: Beijing Baidu Netcom Science Technology Co., Ltd., Beijing (CN)

(72) Inventors: Yanyan LI, Beijing (CN); Peng WANG, Beijing (CN); Hengshu ZHU, Beijing (CN); Shilin WU, Beijing (CN); Dejing DOU, Beijing (CN)

(21) Appl. No.: 17/717,872

(22) Filed: Apr. 11, 2022

(30) Foreign Application Priority Data
Jul. 9, 2021 (CN) 202110778258.4

(51) Int. Cl. G01C 21/00; G01C 21/32; G06F 16/29

(52) U.S. Cl. CPC G01C 21/3867; G01C 21/32; G06F 16/29

(57) ABSTRACT

The present disclosure provides a method and apparatus for generating an electronic map, an electronic device and a storage medium, and relates to the field of data processing technology. A specific implementation comprises: establishing a plurality of groups of corresponding relationships between enterprise names and enterprise addresses using network data; determining respectively a fine-grained region where each enterprise address is located; and creating an enterprise electronic map of the fine-grained region based on the corresponding relationships between the enterprise names and the enterprise addresses and the fine-grained region where the each enterprise address is located. A corresponding relationship between an enterprise name and an enterprise address is established using existing network data.

### CROSS-REFERENCE TO RELATED APPLICATIONS

This application claims priority to Chinese Patent Application No. 202110778258.4, filed with the China National Intellectual Property Administration (CNIPA) on Jul. 9, 2021, the contents of which are incorporated herein by reference in their entirety.

### TECHNICAL FIELD

The present disclosure relates to the field of data processing technology, and particularly to a method and apparatus for generating an electronic map, an electronic device and a storage medium.

### BACKGROUND

An electronic map is a digital map, which is a map that is stored and consulted in a digital form using the computer technology. In general, the way in which the electronic map stores information is to store the information using vector images. The scale of the map can be enlarged, reduced or rotated without affecting the display effect. The electronic map can easily combine and stitch elements in the content of an ordinary map in any form to form a new map. The electronic map can be drawn and outputted at any scale and in any range, and thus can be used in many departments such as an urban planning and construction department, a transportation department, a tourism department, and a vehicle navigation department. The electronic map changes the daily work of various departments from browsing of a pile of maps to the work in front of computers, which makes the daily work scientific, accurate and intuitive, thus greatly improving the efficiency.

### SUMMARY

The present disclosure provides a method and apparatus for generating an electronic map, an electronic device and a storage medium.

In a first aspect, embodiments of the present disclosure provide a method for generating an electronic map, comprising:

establishing a plurality of groups of corresponding relationships between enterprise names and enterprise addresses using network data;

determining respectively a fine-grained region where each enterprise address is located; and

creating an enterprise electronic map of the fine-grained region based on the corresponding relationships between the enterprise names and the enterprise addresses and the fine-grained region where the each enterprise address is located.

In a second aspect, embodiments of the present disclosure provide an apparatus for generating an electronic map, comprising:

a corresponding relationship establishing module, configured to establish a plurality of groups of corresponding relationships between enterprise names and enterprise addresses using network data;

an enterprise address mapping module, configured to determine respectively a fine-grained region where each enterprise address is located; and

an electronic map creating module, configured to create an enterprise electronic map of the fine-grained region based on the corresponding relationships between the enterprise names and the enterprise addresses and the fine-grained region where the each enterprise address is located.

In a third aspect, embodiments of the present disclosure provide an electronic device, comprising: one or more processors; and a memory, storing one or more programs, wherein the one or more programs, when executed by the one or more processors, cause the one or more processors to implement the method for generating an electronic map provided by the first aspect.

In a fourth aspect, embodiments of the present disclosure provide a computer-readable medium, storing a computer program thereon, wherein the program, when executed by a processor, causes the processor to implement the method for generating an electronic map provided by the first aspect.

In a fifth aspect, an embodiment of the present disclosure provides a computer program product, comprising a computer program, wherein the computer program, when executed by a processor, implements the method for generating an electronic map provided by the first aspect.

It should be understood that the content described in this portion is not intended to identify key or important features of the embodiments of the present disclosure, and is not used to limit the scope of the present disclosure. Other features of the present disclosure will be easily understood through the following description.

### BRIEF DESCRIPTION OF THE DRAWINGS

The accompanying drawings are used for a better understanding of the scheme, and do not constitute a limitation to the present disclosure. Here:

FIG. 1 is a first schematic diagram of a method for generating an electronic map according to the present disclosure;

FIG. 2 is a schematic diagram of a fine-grained region division approach according to the present disclosure;

FIG. 3 is a schematic diagram of a possible implementation of step S101 according to the present disclosure;

FIG. 4 is a second schematic diagram of the method for generating an electronic map according to the present disclosure;

FIG. 5 is a schematic diagram of an apparatus for generating an electronic map according to the present disclosure; and

FIG. 6 is a block diagram of an electronic device used to implement the method for generating an electronic map according to embodiments of the present disclosure.

### DETAILED DESCRIPTION OF EMBODIMENTS

Exemplary embodiments of the present disclosure are described below in combination with the accompanying drawings, and various details of the embodiments of the present disclosure are included in the description to facilitate understanding, and should be considered as exemplary only. Accordingly, it should be recognized by one of ordinary skill in the art that various changes and modifications may be made to the embodiments described herein without departing from the scope and spirit of the present disclosure. Also, for clarity and conciseness, descriptions for well-known functions and structures are omitted in the following description.

An enterprise electronic map is an electronic map recording the location/region where an enterprise is located. In the field of ToB (To Business) such as the field of enterprise portrait, the field of enterprise knowledge graph and the field of enterprise talent research, the location/region where the enterprise is located has an important research value. A research is performed on the business condition of the enterprise, the flow of talent of the enterprise, etc. through the density and migration of the stream of people in the location/region where the enterprise is located, which has an important research value as compared with a sampling survey. The enterprise electronic map is widely applied in enterprise related researches, real estate investments, and other fields.

In the prior art, the creation of the enterprise electronic map is implemented by means of a manual annotation, that is, the enterprise is manually annotated on the location/region corresponding to the electronic map. However, the efficiency of the generation of the enterprise electronic map is low by means of the manual annotation.

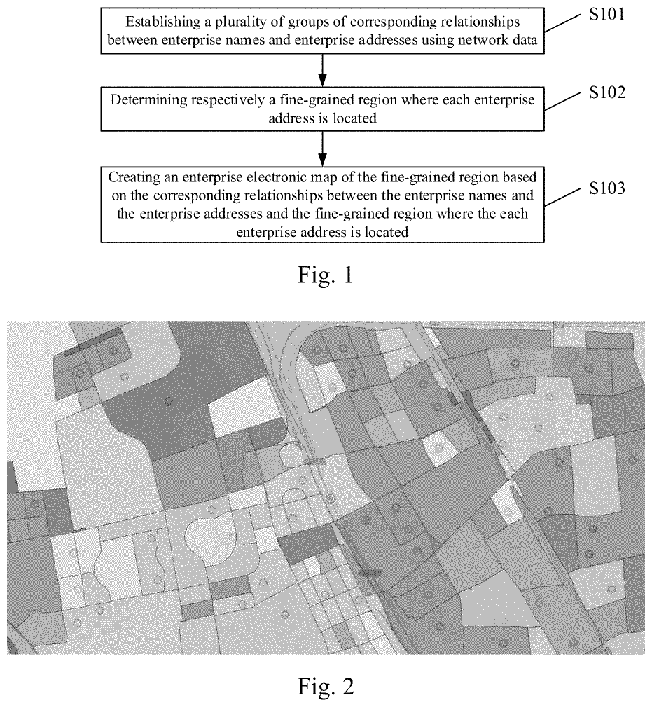

The present disclosure provides a method for generating an electronic map. Referring to FIG. 1, the method includes:

S101, establishing a plurality of groups of corresponding relationships between enterprise names and enterprise addresses using network data.

The method for generating an electronic map according to the embodiment of the present disclosure may be implemented by an electronic device. Specifically, the electronic device may be a personal computer, a smartphone, a server, or the like.

The network data may be data acquired through the Internet, for example, a corresponding relationship between an enterprise name and an enterprise address that is acquired from advertisement data of the Internet, a corresponding relationship between an enterprise name and an enterprise address that is acquired from recruitment information of the Internet, or a corresponding relationship between an enterprise name and an enterprise address that is acquired from a commodity tag of the Internet. In an example, if advertisement data A of the Internet includes an enterprise name AAA and an enterprise address BBB, the corresponding relationship between the enterprise name AAA and the enterprise address BBB is established, which is referred to as a corresponding relationship between one group of an enterprise name and an enterprise address. The enterprise in the embodiment of the present disclosure is a broad concept, including a factory, a company, a hospital, a supermarket, a restaurant, an affiliate, a scientific research institute, a philanthropic organization and the like, which are all within the scope of protection of the present disclosure.

A corresponding relationship between an enterprise name and an enterprise address is established through network data (e.g., enterprise recruitment data), to build a corresponding relationship set C={(c₀, l₀), (c₁, l₁), (c₂, l₂) . . . (cₙ, lₙ)}. Here, C denotes a corresponding relationship set between enterprise names and enterprise addresses, cₙ denotes an n-th enterprise name, lₙ denotes an n-th enterprise address, and the n-th enterprise name and the n-th enterprise address form a corresponding relationship between one group of an enterprise name and an enterprise address. In an example, the corresponding relationship between one group of the enterprise name and the enterprise address is a one-to-one relationship between the enterprise name and the enterprise address. For a situation where one enterprise name corresponds to a plurality of enterprise addresses or a situation where a plurality of enterprise names correspond to one enterprise address, a one-to-one corresponding relationship between an enterprise name and an enterprise address needs to be established, respectively.

S102, determining respectively a fine-grained region where each enterprise address is located.

The fine-grained region may be a pre-divided electronic map region. In an example, an electronic map may be divided into a plurality of fine-grained regions according to a preset grid size, and a grid may be set to a square or a rectangle. The size of the grid may be customized according to an actual requirement. The finer the required fine granularity of the enterprise electronic map is, the smaller the size of the grid is. In an example, an electronic map may be divided into a plurality of fine-grained regions or the like, according to a road or a boundary AOI (area of interest) of a POI (point of interest) in the real world or with an actual target in the real world (e.g., a natural feature such as a river, a canyon and a mountain) as a boundary. A possible approach of dividing a map region with a block as a fine-grained region may be as indicated in FIG. 2. Specifically, the electronic map mentioned in the above embodiment may be a pre-created electronic map of a designated region in the real world, or may directly use a created electronic map, which is within the scope of protection of the present disclosure.

According to each enterprise address in the corresponding relationship, the fine-grained region where the enterprise address is located may be determined. In a possible implementation, the determining respectively a fine-grained region where each enterprise address is located includes: determining, for the each enterprise address, geographical coordinates corresponding to the enterprise address through an inverse-geographical information positioning approach according to a semantic meaning of the enterprise address, and determining the fine-grained region where the enterprise address is located according to the geographical coordinates corresponding to the enterprise address.

For the corresponding relationship set C, the enterprise address lₙ is first associated with the corresponding region (Region), which is referred to herein as a fine-grained region. The corresponding coordinates of lₙ are acquired through the inverse-GEO (geographical information positioning) approach according to the semantic meaning of the enterprise address, that is, the coordinates are queried in reverse through the position of the semantic meaning. In an example, if an enterprise address refers to Building B, AAA Industrial Park, then the coordinates of Building B in AAA Industrial Park can be queried and obtained as XXXX through the inverse-GEO. After the coordinates are acquired, the fine-grained region where Building B of AAA Industrial Park is may be determined according to the coordinate range covered by each fine-grained region. In the embodiment of the present disclosure, it is possible to quickly and accurately determine the fine-grained region where the each enterprise address is located through the inverse-geographical information positioning approach.

S103, creating an enterprise electronic map of the fine-grained region based on the corresponding relationships between the enterprise names and the enterprise addresses and the fine-grained region where the each enterprise address is located.

After the fine-grained region where the enterprise address is located is obtained, the enterprise name needs to be marked in the corresponding fine-grained region, thus obtaining a corresponding relationship set between fine-grained regions and enterprise names: Rₑ={(c₀, r₀), (c₁, r₁), (c₂, r₂) . . . (cₙ, rₙ)}. Here, Rₑ denotes the corresponding relationship set between the fine-grained regions and the enterprise names, cₙ denotes an n-th enterprise name, and rₙ denotes an n-th fine-grained region. For any fine-grained region rᵢ, a corresponding enterprise name list (cᵢ, cᵢ₊₁, . . . cᵢ₊ₙ) is obtained, and the enterprise name list is the enterprise tag corresponding to the region rᵢ, thus creating the enterprise electronic map of the fine-grained region. In an example, in addition to the enterprise name, the enterprise address corresponding to each enterprise name may be associated displayed in the enterprise electronic map of the fine-grained region.

For example, a corresponding relationship between one group of an enterprise name and an enterprise address refers to that an enterprise name AAA corresponds to an enterprise address BBB. If the enterprise address BBB is in a fine-grained region CCC, the enterprise name AAA is marked in the fine-grained region CCC, thereby creating the enterprise electronic map of the fine-grained region. In addition, the enterprise address BBB may be associated on the enterprise name AAA of the fine-grained region CCC.

In the embodiment of the present disclosure, the corresponding relationship between the enterprise name and the enterprise address is established using existing network data. Accordingly, according to the fine-grained region where the enterprise address is located, the marking of the enterprise name in the fine-grained region may be completed, thus implementing the creation of the enterprise electronic map of the fine-grained region. Moreover, as compared with the manual annotation, the period during which the enterprise electronic map is created can be greatly shortened, thus greatly saving the construction cost.

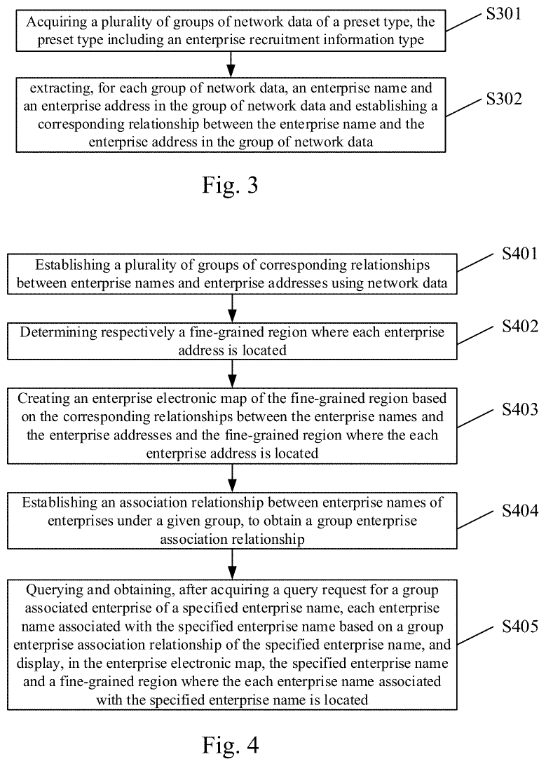

In a possible implementation, referring to FIG. 3, the establishing a plurality of groups of corresponding relationships between enterprise names and enterprise addresses using network data includes:

S301, acquiring a plurality of groups of network data of a preset type, the preset type including an enterprise recruitment information type.

The preset type may be customized according to an actual situation. The preset type includes at least the enterprise recruitment information type, and may further include an advertisement information type, a commodity tag type, and the like. One group of network data refers to one group of structured network data. For example, one group of network data may be one piece of recruitment information, one piece of advertisement information, one commodity tag, or the like.

S302, extracting, for each group of network data, an enterprise name and an enterprise address in the group of network data and establishing a corresponding relationship between the enterprise name and the enterprise address in the group of network data.

The enterprise name and the enterprise address in the network data may be recognized through a related character recognition technology. In general, in the network data of the preset type, a corresponding keyword is directly recorded, which can facilitate the extraction for the enterprise name and the enterprise address. For example, taking enterprise recruitment information as an example, keywords such as “XXX recruitment,” “company name: XXX,” “work location: XXX” and “company address: XXX” are generally recorded. Accordingly, the extraction for the enterprise name may be completed by directly finding a keyword such as “recruitment” and “company name,” and the extraction for the enterprise address may be completed by directly finding a keyword such as “work location” and “company address.” In addition, the extraction for the enterprise name and the enterprise address may be performed through a pre-trained deep learning network.

After the enterprise name and the enterprise address are extracted, the corresponding relationship between the enterprise name and the enterprise address needs to be established. In an example, one group of network data only includes one enterprise name and one enterprise address. In this case, the association relationship between the enterprise name and the enterprise address may be directly established. In an example, if one group of network data includes one enterprise name and a plurality of enterprise addresses, the corresponding relationships between the enterprise name and the enterprise addresses may be respectively established. For example, if one piece of advertisement information includes one enterprise name and a plurality of enterprise addresses, indicating that the enterprise name corresponds to a plurality of branches or office locations, the association relationships between the enterprise name and the enterprise addresses may be respectively established.

In the embodiment of the present disclosure, as compared with the extraction of the enterprise name and the enterprise address from massive big data, the extraction of the enterprise name and the enterprise address from the network data of the preset type (e.g., the enterprise recruitment information type) can improve the extraction efficiency of the enterprise name and the enterprise address, thereby improving the creation efficiency of the enterprise electronic map.

In some scenarios, one group of network data may include a plurality of enterprise names and a plurality of enterprise addresses. In a possible implementation, the extracting, for each group of network data, an enterprise name and an enterprise address in the group of network data and establishing a corresponding relationship between the enterprise name and the enterprise address in the group of network data includes the following steps:

In step 1, for the each group of network data, the enterprise name and the enterprise address in the group of network data are extracted.

In step 2, in a situation where the group of network data includes a plurality of enterprise names and a plurality of enterprise addresses, a writing direction of the group of network data is determined. Here, the above writing direction includes a horizontal direction and a vertical direction.

In step 3, a distance between any enterprise name and enterprise address in the group of network data are respectively calculated.

In step 4, the corresponding relationship between the enterprise name and the enterprise address in the group of network data is determined according to the writing direction of the group of network data and the distance between any enterprise name and enterprise address.

In an example, the above-mentioned writing direction includes a horizontal direction and a vertical direction. The horizontal direction means that the characters are read and written in the order of the horizontal direction, and the vertical direction is that the characters are read and written in the vertical order. The distance between enterprise name and enterprise address may include a horizontal distance and a vertical distance

The horizontal distance refers to a distance between an enterprise name and an enterprise address in the network data in the horizontal direction. In an example, the horizontal distance may be a column spacing. The vertical distance refers to a distance between an enterprise name and an enterprise address in the network data in the vertical direction. In an example, the vertical distance may be a row spacing.

In an example, the horizontal distance between the enterprise name and the enterprise address is the column spacing between two characters having a closest horizontal distance in the enterprise name and the enterprise address. The vertical distance between the enterprise name and the enterprise address is the row spacing between two characters having a closest vertical distance in the enterprise name and the enterprise address.

In a situation where the writing direction of the group of network data is the horizontal direction, for each enterprise name in the group of network data, an enterprise address having a smallest vertical distance from the enterprise name is selected, and a corresponding relationship is established with the enterprise name. In a situation where there are a plurality of enterprise addresses having the smallest vertical distance, an enterprise address having a smallest horizontal distance from the enterprise name is selected from the enterprise addresses having the smallest vertical distance, and a corresponding relationship is established with the enterprise name.

In an example, the group of network data includes an enterprise name A, an enterprise name B, an enterprise address 1 and an enterprise address 2, and the writing direction of the group of network data is the horizontal direction. Through the calculation, it is obtained that the vertical distance between the enterprise name A and the enterprise address 1 is Y1 (row spacing is Y1), and that the vertical distance between the enterprise name A and the enterprise address 2 is Y2 (row spacing is Y2), where Y1 is less than Y2. Accordingly, the enterprise address having a smallest vertical distance from the enterprise name A is the enterprise address 1, and the corresponding relationship between the enterprise name A and the enterprise address 1 is established.

In an example, the group of network data includes an enterprise name A, an enterprise name B, an enterprise address 1 and an enterprise address 2, and the writing direction of the group of network data is the horizontal direction. Through the calculation, it is obtained that the vertical distance between the enterprise name A and the enterprise address 1 is Y3 (row spacing is Y3), and that the vertical distance between the enterprise name A and the enterprise address 2 is Y3 (row spacing is Y3). Accordingly, the enterprise address having a smallest vertical distance from the enterprise name A refers to the enterprise address 1 and the enterprise address 2. The horizontal distance between the enterprise name A and the enterprise address 1 is X1 (column spacing is X1), and the horizontal distance between the enterprise name A and the enterprise address 2 is X2 (column spacing is X2). In the enterprise addresses having the smallest vertical distance from the enterprise name A, the horizontal distance between the enterprise name A and the enterprise address 1 is the smallest. Accordingly, the corresponding relationship between the enterprise name A and the enterprise address 1 is established.

In a situation where the writing direction of the group of network data is the vertical direction, for the each enterprise name in the group of network data, an enterprise address having a smallest horizontal distance from the enterprise name is selected, and a corresponding relationship is established with the enterprise name. In a situation where there are a plurality of enterprise addresses having the smallest horizontal distance, an enterprise address having a smallest vertical distance from the enterprise name is selected from the enterprise addresses having the smallest horizontal distance, and a corresponding relationship is established with the enterprise name.

In an example, the group of network data includes an enterprise name A, an enterprise name B, an enterprise address 1 and an enterprise address 2, and the writing direction of the group of network data is the vertical direction. Through the calculation, it is obtained that the horizontal distance between the enterprise name A and the enterprise address 1 is X1 (column spacing is X1), and that the horizontal distance between the enterprise name A and the enterprise address 2 is X2 (column spacing is X2), where X1 is less than X2. Accordingly, the enterprise address having a smallest horizontal distance from the enterprise name A is the enterprise address 1, and the corresponding relationship between the enterprise name A and the enterprise address 1 is established.

In an example, the group of network data includes an enterprise name A, an enterprise name B, an enterprise address 1 and an enterprise address 2, and the writing direction of the group of network data is the vertical direction. Through the calculation, it is obtained that the horizontal distance between the enterprise name A and the enterprise address 1 is X3 (column spacing is X3), and that the horizontal distance between the enterprise name A and the enterprise address 2 is X3 (column spacing is X3). Accordingly, the enterprise address having a smallest horizontal distance from the enterprise name A refers to the enterprise address 1 and the enterprise address 2. The vertical distance between the enterprise name A and the enterprise address 1 is Y1 (row spacing is Y1), and the vertical distance between the enterprise name A and the enterprise address 2 is Y2 (row spacing is Y2), where Y1 is less than Y2. In the enterprise addresses having the smallest horizontal distance from the enterprise name A, the vertical distance between the enterprise name A and the enterprise address 1 is the smallest. Accordingly, the corresponding relationship between the enterprise name A and the enterprise address 1 is established.

In the embodiment of the present disclosure, for the scenario in which one group of network data includes a plurality of enterprise names and a plurality of enterprise addresses, the corresponding relationship between the enterprise name and the enterprise address can be accurately established by distinguishing the writing direction and by using the horizontal distance and the vertical distance.

In an other possible implementation, the establishment of the corresponding relationship between the enterprise name and the enterprise address may alternatively be implemented through a deep learning network (e.g., a convolutional neural network and an LSTM (long short-term memory), which is within the scope of protection of the present disclosure.

Embodiments of the present disclosure further provide a method for generating an electronic map, referring to FIG. 4, the method includes:

S401, establishing a plurality of groups of corresponding relationships between enterprise names and enterprise addresses using network data.

S402, determining respectively a fine-grained region where each enterprise address is located.

S403, creating an enterprise electronic map of the fine-grained region based on the corresponding relationships between the enterprise names and the enterprise addresses and the fine-grained region where the each enterprise address is located.

S404, establishing an association relationship between enterprise names of enterprises under a given group, to obtain a group enterprise association relationship.

S405, querying and obtaining, after acquiring a query request for a group associated enterprise of a specified enterprise name, each enterprise name associated with the specified enterprise name based on a group enterprise association relationship of the specified enterprise name, and display, in the enterprise electronic map, the specified enterprise name and a fine-grained region where the each enterprise name associated with the specified enterprise name is located.

In many cases, the same group may include a plurality of enterprises. For example, one listed group often includes a plurality of registered enterprises. An associated enterprise of an enterprise may be obtained through an enterprise knowledge graph. For example, an enterprise cᵢ is controlled by cᵢ₊₁ and is a branch office of cᵢ₊₂, thus establishing the association relationships between the enterprise names of the enterprises under the same group. The corresponding relationship (cᵢ, lᵢ) between one group of the enterprise name and the enterprise address is thus extended to (cᵢ₊₁, lᵢ) and (cᵢ₊₂, lᵢ). Finally, the group-enterprise association relationship is obtained as: Q={(c₀, l₀), (c₁, l₁), (c₂, l₂) . . . (cₙ, lₙ)}.

When a user wishes to perform a query on the each enterprise associated with the specified enterprise name, the query request representing a query for the group associated enterprise of the specified enterprise name is inputted. The query request includes an identifier of the specified enterprise name. Each group enterprise association relationship is searched according to the identifier of the specified enterprise name, to obtain the group enterprise association relationship in which the specified enterprise name is. The each enterprise name is obtained from the group enterprise association relationship, and displayed in the enterprise electronic map of the fine-grained region. Accordingly, the query for the associated enterprise and the displaying of the associated enterprise in the map are implemented, which can meet various requirements of the user.

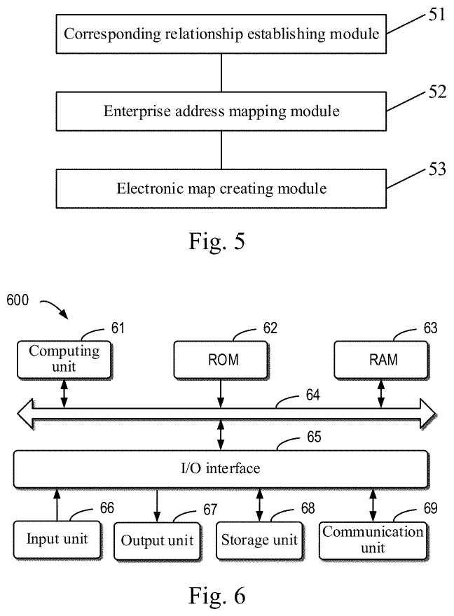

The present disclosure further provides an apparatus for generating an electronic map. Referring to FIG. 5, the apparatus for generating an electronic map includes:

a corresponding relationship establishing module 51, configured to establish corresponding relationships between a plurality of groups of enterprise names and enterprise addresses using network data;

an enterprise address mapping module 52, configured to determine respectively a fine-grained region where each enterprise address is located; and

an electronic map creating module 53, configured to create an enterprise electronic map of the fine-grained region based on the corresponding relationships between the enterprise names and the enterprise addresses and the fine-grained region where the each enterprise address is located.

In a possible implementation, the corresponding relationship establishing module 51 includes:

a network data acquiring submodule, configured to acquire a plurality of groups of network data of a preset type, the preset type comprising an enterprise recruitment information type; and

a name address associating submodule, configured to extract, for each group of network data, an enterprise name and an enterprise address in the group of network data and establish a corresponding relationship between the enterprise name and the enterprise address in the group of network data.

In a possible implementation, the name address associating submodule is configured to:

extract, for the each group of network data, the enterprise name and the enterprise address in the group of network data, and determine, in a situation where the group of network data includes a plurality of enterprise names and a plurality of enterprise addresses, a writing direction of the group of network data;

calculate respectively a distance between any enterprise name and enterprise address in the group of network data;

determine the corresponding relationship between the enterprise name and the enterprise address in the group of network data according to the writing direction of the group of network data and the distance between any enterprise name and enterprise address.

In a possible implementation, the enterprise address mapping module 52 is configured to: determine, for the each enterprise address, geographical coordinates corresponding to the enterprise address through an inverse-geographical information positioning approach according to a semantic meaning of the enterprise address, and determine the fine-grained region where the enterprise address is located according to the geographical coordinates corresponding to the enterprise address.

In a possible implementation, the apparatus further includes:

a group enterprise associating module, configured to establish an association relationship between enterprise names of enterprises under a given group, to obtain a group enterprise association relationship; and

a group enterprise displaying module, configured to query and obtain, after acquiring a query request for a group associated enterprise of a specified enterprise name, each enterprise name associated with the specified enterprise name based on a group enterprise association relationship of the specified enterprise name, and display, in the enterprise electronic map, the specified enterprise name and a fine-grained region where the each enterprise name associated with the specified enterprise name is located.

In the technical solution of the present disclosure, the acquisition, storage, application, etc. of the information of a user and an enterprise all comply with the provisions of the relevant laws and regulations, and do not violate public order and good customs.

According to an embodiment of the present disclosure, the present disclosure further provides an electronic device, a readable storage medium and a computer program product.

The electronic device includes at least one processor; and a storage device, communicated with the at least one processor. Here, the storage device stores an instruction executable by the at least one processor, and the instruction is executed by the at least one processor, to enable the at least one processor to perform the method for generating an electronic map described in any embodiment of the present disclosure.

The present disclosure further provides a non-transitory computer readable storage medium storing a computer instruction. Here, the computer instruction is used to cause the computer to perform the method for generating an electronic map described in any embodiment of the present disclosure.

The present disclosure further provides a computer program product including a computer program. The computer program, when executed by a processor, implements the method for generating an electronic map described in any embodiment of the present disclosure.

FIG. 8 is a schematic block diagram of an example electronic device 800 that may be used to implement embodiments of the present disclosure. The electronic device is intended to represent various forms of digital computers such as a laptop computer, a desktop computer, a workstation, a personal digital assistant, a server, a blade server, a mainframe computer, and other appropriate computers. The electronic device may alternatively represent various forms of mobile apparatuses such as personal digital processing, a cellular telephone, a smart phone, a wearable device and other similar computing apparatuses. The parts shown herein, their connections and relationships, and their functions are only as examples, and not intended to limit implementations of the present disclosure as described and/or claimed herein.

As shown in FIG. 6, the device 600 includes a computation unit 61, which may execute various appropriate actions and processes in accordance with a computer program stored in a read-only memory (ROM) 62 or a computer program loaded into a random access memory (RAM) 63 from a storage unit 68. The RAM 63 also stores various programs and data required by operations of the device 600. The computation unit 61, the ROM 62 and the RAM 63 are connected to each other through a bus 64. An input/output (I/O) interface 65 is also connected to the bus 64.

The following components in the device 600 are connected to the I/O interface 65: an input unit 66, for example, a keyboard and a mouse; an output unit 67, for example, various types of displays and a speaker; a storage device 68, for example, a magnetic disk and an optical disk; and a communication unit 69, for example, a network card, a modem, a wireless communication transceiver. The communication unit 69 allows the device 600 to exchange information/data with an other device through a computer network such as the Internet and/or various telecommunication networks.

The computation unit 61 may be various general-purpose and/or special-purpose processing assemblies having processing and computing capabilities. Some examples of the computation unit 61 include, but not limited to, a central processing unit (CPU), a graphics processing unit (GPU), various dedicated artificial intelligence (AI) computing chips, various processors that run a machine learning model algorithm, a digital signal processor (DSP), any appropriate processor, controller and microcontroller, etc. The computation unit 61 performs the various methods and processes described above, for example, the method for generating an electronic map. For example, in some embodiments, the method for generating an electronic map may be implemented as a computer software program, which is tangibly included in a machine readable medium, for example, the storage device 68. In some embodiments, part or all of the computer program may be loaded into and/or installed on the device 600 via the ROM 62 and/or the communication unit 69. When the computer program is loaded into the RAM 63 and executed by the computation unit 61, one or more steps of the above method for generating an electronic map may be performed. Alternatively, in other embodiments, the computation unit 61 may be configured to perform the method for generating an electronic map through any other appropriate approach (e.g., by means of firmware).

The various implementations of the systems and technologies described herein may be implemented in a digital electronic circuit system, an integrated circuit system, a field programmable gate array (FPGA), an application specific integrated circuit (ASIC), an application specific standard product (ASSP), a system-on-chip (SOC), a complex programmable logic device (CPLD), computer hardware, firmware, software and/or combinations thereof. The various implementations may include: being implemented in one or more computer programs, where the one or more computer programs may be executed and/or interpreted on a programmable system including at least one programmable processor, and the programmable processor may be a particular-purpose or general-purpose programmable processor, which may receive data and instructions from a storage system, at least one input device and at least one output device, and send the data and instructions to the storage system, the at least one input device and the at least one output device.

Program codes used to implement the method of embodiments of the present disclosure may be written in any combination of one or more programming languages. These program codes may be provided to a processor or controller of a general-purpose computer, particular-purpose computer or other programmable data processing apparatus, so that the program codes, when executed by the processor or the controller, cause the functions or operations specified in the flowcharts and/or block diagrams to be implemented. These program codes may be executed entirely on a machine, partly on the machine, partly on the machine as a stand-alone software package and partly on a remote machine, or entirely on the remote machine or a server.

In the context of the present disclosure, the machine-readable medium may be a tangible medium that may include or store a program for use by or in connection with an instruction execution system, apparatus or device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any appropriate combination thereof. A more particular example of the machine-readable storage medium may include an electronic connection based on one or more lines, a portable computer disk, a hard disk, a random-access memory (RAM), a read-only memory (ROM), an erasable programmable read-only memory (EPROM or flash memory), an optical fiber, a portable compact disk read-only memory (CD-ROM), an optical storage device, a magnetic storage device, or any appropriate combination thereof.

To provide interaction with a user, the systems and technologies described herein may be implemented on a computer having: a display device (such as a CRT (cathode ray tube) or LCD (liquid crystal display) monitor) for displaying information to the user; and a keyboard and a pointing device (such as a mouse or a trackball) through which the user may provide input to the computer. Other types of devices may also be used to provide interaction with the user. For example, the feedback provided to the user may be any form of sensory feedback (such as visual feedback, auditory feedback or tactile feedback); and input from the user may be received in any form, including acoustic input, speech input or tactile input.

The systems and technologies described herein may be implemented in: a computing system including a background component (such as a data server), or a computing system including a middleware component (such as an application server), or a computing system including a front-end component (such as a user computer having a graphical user interface or a web browser through which the user may interact with the implementations of the systems and technologies described herein), or a computing system including any combination of such background component, middleware component or front-end component. The components of the systems may be interconnected by any form or medium of digital data communication (such as a communication network). Examples of the communication network include a local area network (LAN), a wide area network (WAN), and the Internet.

A computer system may include a client and a server. The client and the server are generally remote from each other, and generally interact with each other through the communication network. A relationship between the client and the server is generated by computer programs running on a corresponding computer and having a client-server relationship with each other. The server may be a cloud server, a distributed system server, or a server combined with a blockchain.

It should be appreciated that the steps of reordering, adding or deleting may be executed using the various forms shown above. For example, the steps described in embodiments of the present disclosure may be executed in parallel or sequentially or in a different order, so long as the expected results of the technical schemas provided in embodiments of the present disclosure may be realized, and no limitation is imposed herein.

The above particular implementations are not intended to limit the scope of the present disclosure. It should be appreciated by those skilled in the art that various modifications, combinations, sub-combinations, and substitutions may be made depending on design requirements and other factors. Any modification, equivalent and modification that fall within the spirit and principles of the present disclosure are intended to be included within the scope of the present disclosure.

What is claimed is:

1. A method for generating an electronic map, comprising:
establishing a plurality of groups of corresponding relationships between enterprise names and enterprise addresses using network data;
determining respectively a fine-grained region where each enterprise address is located; and
creating an enterprise electronic map of the fine-grained region based on the corresponding relationships between the enterprise names and the enterprise addresses and the fine-grained region where the each enterprise address is located.

2. The method according to claim 1, wherein the establishing a plurality of groups of corresponding relationships between enterprise names and enterprise addresses using network data comprises:
acquiring a plurality of groups of network data of a preset type, the preset type comprising an enterprise recruitment information type; and
extracting, for each group of network data, an enterprise name and an enterprise address in the group of network data and establishing a corresponding relationship between the enterprise name and the enterprise address in the group of network data.

3. The method according to claim 2, wherein the extracting, for each group of network data, an enterprise name and an enterprise address in the group of network data and establishing a corresponding relationship between the enterprise name and the enterprise address in the group of network data comprises:
extracting, for the each group of network data, the enterprise name and the enterprise address in the group of network data, and determining, in a situation where the group of network data comprises a plurality of enterprise names and a plurality of enterprise addresses, a writing direction of the group of network data;
calculating respectively a distance between any enterprise name and enterprise address in the group of network data; and
determining the corresponding relationship between the enterprise name and the enterprise address in the group of network data according to the writing direction of the group of network data and the distance between any enterprise name and enterprise address.

4. The method according to claim 1, wherein the determining respectively a fine-grained region where each enterprise address is located comprises:
determining, for the each enterprise address, geographical coordinates corresponding to the enterprise address through an inverse-geographical information positioning approach according to a semantic meaning of the enterprise address, and determining the fine-grained region where the enterprise address is located according to the geographical coordinates corresponding to the enterprise address.

5. The method according to claim 1, further comprising:
establishing an association relationship between enterprise names of enterprises under a given group, to obtain a group enterprise association relationship; and
querying and obtaining, after acquiring a query request for a group associated enterprise of a specified enterprise name, each enterprise name associated with the specified enterprise name based on a group enterprise association relationship of the specified enterprise name, and displaying, in the enterprise electronic map, the specified enterprise name and a fine-grained region where the each enterprise name associated with the specified enterprise name is located.

6. An electronic device, comprising:
at least one processor; and
a storage device, communicated with the at least one processor,
wherein the storage device stores an instruction executable by the at least one processor, and the instruction is executed by the at least one processor, to enable the at least one processor to perform operations for generating an electronic map, the operations comprising:
establishing a plurality of groups of corresponding relationships between enterprise names and enterprise addresses using network data;
determining respectively a fine-grained region where each enterprise address is located; and
creating an enterprise electronic map of the fine-grained region based on the corresponding relationships between the enterprise names and the enterprise addresses and the fine-grained region where the each enterprise address is located.

7. The device according to claim 6, wherein the establishing a plurality of groups of corresponding relationships between enterprise names and enterprise addresses using network data comprises:
acquiring a plurality of groups of network data of a preset type, the preset type comprising an enterprise recruitment information type; and
extracting, for each group of network data, an enterprise name and an enterprise address in the group of network data and establishing a corresponding relationship between the enterprise name and the enterprise address in the group of network data.

8. The device according to claim 7, wherein the extracting, for each group of network data, an enterprise name and an enterprise address in the group of network data and establishing a corresponding relationship between the enterprise name and the enterprise address in the group of network data comprises:
extracting, for the each group of network data, the enterprise name and the enterprise address in the group of network data, and determining, in a situation where the group of network data comprises a plurality of enterprise names and a plurality of enterprise addresses, a writing direction of the group of network data;
calculating respectively a distance between any enterprise name and enterprise address in the group of network data; and
determining the corresponding relationship between the enterprise name and the enterprise address in the group of network data according to the writing direction of the group of network data and the distance between any enterprise name and enterprise address.

9. The device according to claim 6, wherein the determining respectively a fine-grained region where each enterprise address is located comprises:
determining, for the each enterprise address, geographical coordinates corresponding to the enterprise address through an inverse-geographical information positioning approach according to a semantic meaning of the enterprise address, and determining the fine-grained region where the enterprise address is located according to the geographical coordinates corresponding to the enterprise address.

10. The device according to claim 6, the operations further comprising:
establishing an association relationship between enterprise names of enterprises under a given group, to obtain a group enterprise association relationship; and
querying and obtaining, after acquiring a query request for a group associated enterprise of a specified enterprise name, each enterprise name associated with the specified enterprise name based on a group enterprise association relationship of the specified enterprise name, and displaying, in the enterprise electronic map, the specified enterprise name and a fine-grained region where the each enterprise name associated with the specified enterprise name is located.

11. A non-transitory computer readable storage medium, storing a computer instruction, wherein the computer instruction is used to cause a computer to perform operations for generating an electronic map, the operations comprising:
establishing a plurality of groups of corresponding relationships between enterprise names and enterprise addresses using network data;
determining respectively a fine-grained region where each enterprise address is located; and
creating an enterprise electronic map of the fine-grained region based on the corresponding relationships between the enterprise names and the enterprise addresses and the fine-grained region where the each enterprise address is located.

12. The medium according to claim 11, wherein the establishing a plurality of groups of corresponding relationships between enterprise names and enterprise addresses using network data comprises:
acquiring a plurality of groups of network data of a preset type, the preset type comprising an enterprise recruitment information type; and
extracting, for each group of network data, an enterprise name and an enterprise address in the group of network data and establishing a corresponding relationship between the enterprise name and the enterprise address in the group of network data.

13. The medium according to claim 12, wherein the extracting, for each group of network data, an enterprise name and an enterprise address in the group of network data and establishing a corresponding relationship between the enterprise name and the enterprise address in the group of network data comprises:
extracting, for the each group of network data, the enterprise name and the enterprise address in the group of network data, and determining, in a situation where the group of network data comprises a plurality of enterprise names and a plurality of enterprise addresses, a writing direction of the group of network data;
calculating respectively a distance between any enterprise name and enterprise address in the group of network data; and
determining the corresponding relationship between the enterprise name and the enterprise address in the group of network data according to the writing direction of the group of network data and the distance between any enterprise name and enterprise address.

14. The medium according to claim 11, wherein the determining respectively a fine-grained region where each enterprise address is located comprises:
determining, for the each enterprise address, geographical coordinates corresponding to the enterprise address through an inverse-geographical information positioning approach according to a semantic meaning of the enterprise address, and determining the fine-grained region where the enterprise address is located according to the geographical coordinates corresponding to the enterprise address.

15. The medium according to claim 11, the operations further comprising:
establishing an association relationship between enterprise names of enterprises under a given group, to obtain a group enterprise association relationship; and
querying and obtaining, after acquiring a query request for a group associated enterprise of a specified enterprise name, each enterprise name associated with the specified enterprise name based on a group enterprise association relationship of the specified enterprise name, and displaying, in the enterprise electronic map, the specified enterprise name and a fine-grained region where the each enterprise name associated with the specified enterprise name is located.
